(19) United States
(12) Patent Application Publication
(10) Pub. No.: US 2007/0152895 A1
(43) Pub. Date: Jul. 5, 2007

(54) Vehicle antenna

(76) Inventors: Jurgen Heuser, Neckartailfingen (DE); Dieter Schenkyr, Lenningen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/559,566

(22) PCT Filed: May 4, 2004
(86) PCT No.: PCT/EP04/04690

§ 371 Date: Jan. 29, 2007

(30) Foreign Application Priority Data
May 26, 2003 (DE) 103 23 557.4

(51) Int. Cl. H01Q 1/32

(52) U.S. Cl. 343/713; 343/704

(57) ABSTRACT

In the edge area of a window (8) a vehicle (5) is provided with a completely opaque black print (9) and a grey print (10) with grid-like apertures (11) adjacent thereto in a direction toward the window center that together form an obscuring area (7), on the vehicle facing side of which a vehicle antenna (1) consisting of an antenna structure (2) and a feed line (3) is arranged. According to the invention, the antenna structure (2) is at least partially arranged within the region of the grey print (10) and designed such that it is completely covered by the interface (13) formed by the apertures (11). Thus the antenna structure can be placed in greater distance to the vehicle body, by which the electrical adjustment of the antenna is improved. Further advantages result from the embodiments of and modifications to the invention described in the dependent claims.

The invention relates to a vehicle antenna according to the preamble of claim 1.

It is known from DE 44 03 643 A1 to mount an antenna in a groove or seat of a metallic vehicle body, particularly in the upper edge area of an opening in a vehicle body intended to hold a windshield. When the window glass is installed, the grooves or seats, and thus also the antennas, are covered by the complementary upper edges of the glass and are therefore mechanically protected and moisture-tight.

The mentioned window-glass edge is provided on its inner face with a so-called black print made of nonconductive material that conceals the antenna thanks to its completely black surface, so that neither the antenna nor other possibly present devices associated with the antenna are prominent or can be seen by third parties.

To the same end, it is known to apply antenna structures directly on the black print.

Due to the strong difference in contrast between the window glass and the black print, the latter is optically visible and quite prominent. In order to avoid this effect, it is widely known to provide an obscuring area consisting of a black print provided in the edge area of the window and, adjacent thereto in the direction of the window center, a grey print that like the black region is provided with grid-like apertures increasing in size from the black print to the window center, thus causing a smooth visual transition.

In order to complete the visual concealment, the antenna structures of these obscuring areas are provided within the completely black regions and thus are close to the metal vehicle body, just as is the case when nothing but a black print is provided. Thus the ability to electrically tune the antenna is reduced such that in many cases it can be no longer be done.

Therefore, it is the object of the invention to further develop a vehicle antenna of the above-described kind in such way that the antenna structure is completely concealed in the obscuring area and is thus invisible; and simultaneously to develop it such that good electrical properties are achieved for the antenna by means of as simple and cost-efficient a method as possible.

This object is attained by the characterizing features of claim 1. Thus, the antenna structure is completely invisible, just as if it was provided on the black print as known; interference by the metallic body on the antenna tuning is significantly reduced due to the provision of the antenna structure in the grey print that allows the antenna to be placed at a greater spacing from the vehicle body.

The greatest possible distance is limited by the necessary conductor surfaces on the one hand and on the other hand by the interfaces that decrease in size in direction to the window center.

The degree of freedom regarding the shape of the antenna structure with the solution according to the invention is in principle limited, compared to an arrangement on the black print, yet it permits the realization of all practically expedient embodiments and is significantly increased compared to installation directly in the transparent section of vehicle window.

It is to be noted that the invention can also be applied when the obscuring area consists of nothing but a grey print, as long as it is large enough to allow the antenna structure to be placed at a sufficient spacing from the body to allow the intended electrical of the vehicle antenna.

Advantageous embodiments, designs and modifications of the invention are indicated in the dependent claims.

In an embodiment according to claim 2, the antenna structure does not necessarily have to be black since it is invisible from the outside, independently of the color of the antenna structure applied to the obscuring area. Thus, the material of the antenna structure with regard to its electrical and mechanical characteristics as well as to cost can be optimally selected.

According to claim 3, the antenna structure is installed rationally and in a stable and exact position on the obscuring area when it is printed on the area (for example by means of screen printing).

Claims 4 and 5 describe two alternative possibilities for the design of the antenna structure.

In an embodiment according to claim 4, the interfaces in the area of the grey print provided to conceal the antenna structure are optimally used, which advantageously leads to an extended antenna surface as well as to the lowest possible transition resistance of the interfaces in their narrow sections and thus, in total, only a little space is lost. On the other hand, due to this fact, comparatively small process tolerances need be observed in the successive passes regarding the application of the obscuring area onto the window and of the antenna structure onto the obscuring area, in order to ensure that the antenna structure really is completely concealed by the interfaces.

In comparison, such safe concealment can also be achieved in an embodiment according to claim 5, when the process tolerances regarding the two manufacturing processes mentioned (e.g. screen printing technique) are comparatively high regarding their exact relative positioning.

In principle the apertures in the grey print may have any shape, but according to claim 6 it is convenient to provide all the apertures in the grey print in the same shape, since the antenna should be as little visible as possible.

Practical tests showed that particularly the shapes indicated in claims 7 and 8, as well as combinations thereof (for example square apertures with rounded corners), have an advantageously limited visual effect. In addition, their production is uncomplicated and they are specially suited for practically expedient designs of antenna structures.

Compared to antenna structures with straight (erect) conductors, the structures indicated in claims 9 and 10 are much better suited for an invisible arrangement, even in sections of the grey print that are very distant from the vehicle body. Moreover, they have the advantage of also being inductive, which may for example result in an improved decoupling from other independent window antennas (e.g. antennas of heat conductors in the rear windshields of vehicles). Finally, the meander-like or sawtooth-like design results in an electrical extension of the antenna, thus the antenna needs to be less extended in length with the same frequency range.

By the design described in claim 11, both a small transition resistance of the antenna conductor in the area of the narrow interfaces and a very safe contact are achieved.

The invention is further explained in the figures by means of an illustrated embodiment. Therein in partial view:

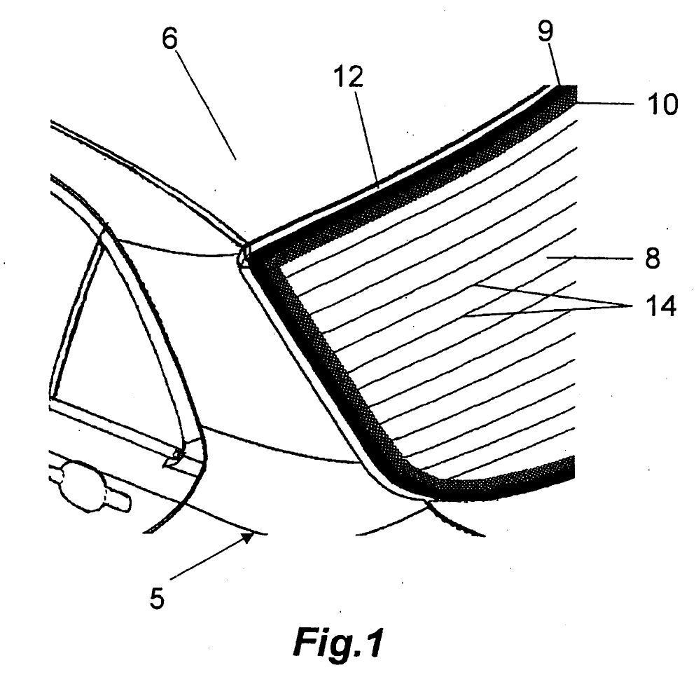

FIG. 1 shows a perspective view of a vehicle with an obscuring area in the edge area of the rear windshield;

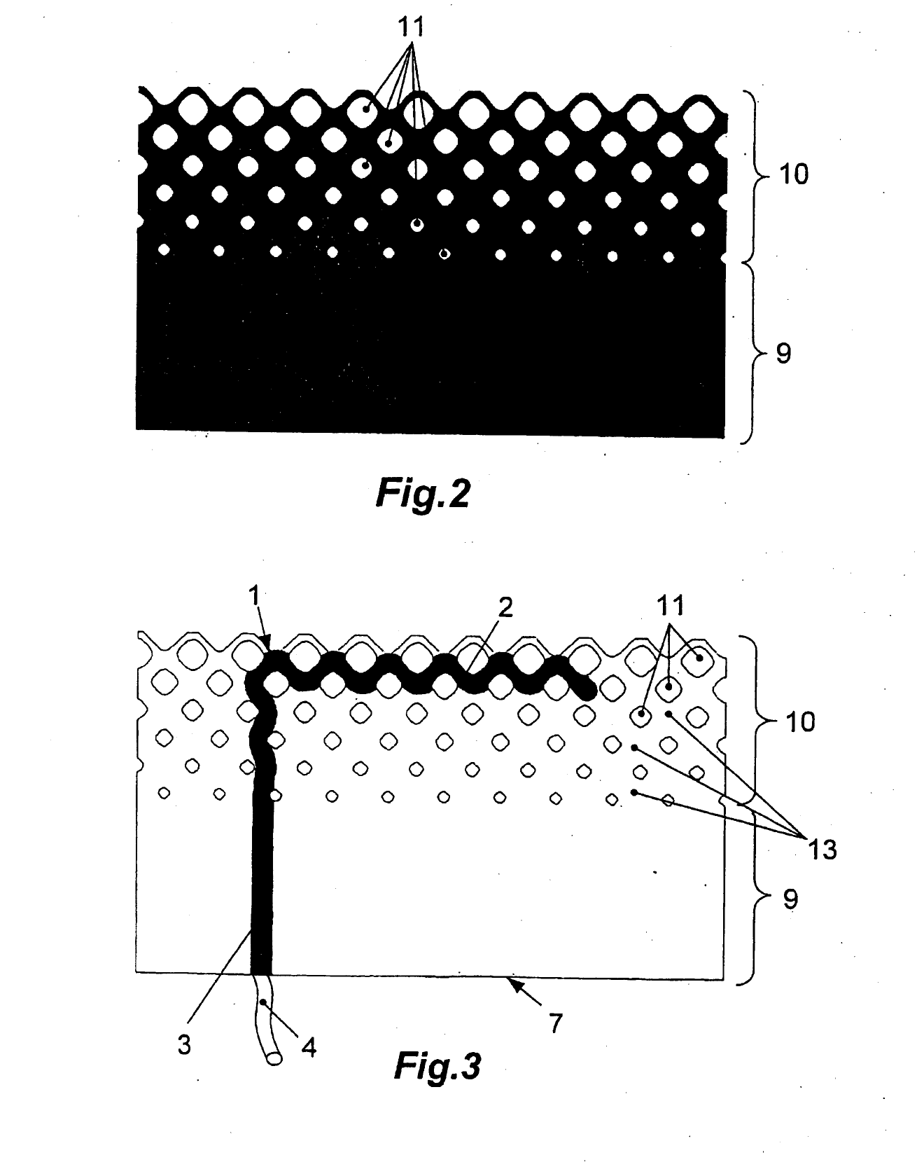

FIG. 2 shows a basic view of the obscuring area; and

FIG. 3 shows a basic view of the obscuring area without blackening and thus with the vehicle antenna visible.

The vehicle antenna consists of an antenna structure formed of a conductor trace 2 in a more or less meander-like shape and a feed conductor trace 3 that is connected with a receiver cable 4.

The antenna structure is silk screened to the surface of a nonconductive obscuring area 7, facing the interior of the vehicle 5 with its metal body 6 and printed on the inner edge area of the vehicle's 5 rear windshield 8.

The obscuring area 7 consists of a black print 9 running along the window edge and a grey print 10 adjacent thereto toward the window center. The black print 9 consists of a solid black region, while the grey print 10 is a black region provided with grid-like square apertures 11 with rounded corners, the apertures 11 being provided in rows and increasing in size toward the window center so that a visually smooth transition from the black print 9 to the rear windshield 8 is achieved.

The apertures 11 of adjoining rows are staggered and due to their size they project into the regions lying between the adjoining apertures of the respectively next row in the exterior rows pointing towards the window center.

The conductor trace 2 of the antenna structure runs in a meander-like row between the outer rows of the apertures 11 of the grey print 10 and thus at a maximal distance from the roof edge 12 of the metal body surface 6 (in this case the roof surface of the vehicle 5), that thus interferes as little as possible on the antenna structure, so that in this respect the best possible electrical tuning of the vehicle antenna 1 is achieved.

In addition, the width of the conductor trace 2 is selected such that it corresponds to the smallest distance between two apertures 11 of adjoining rows. By this largest possible width in the narrow sections of the interface 13, the interface 13, which is available for concealment of the antenna structure, is optimally used without the antenna structure being visible at the apertures 11. Furthermore, an extended antenna surface as well as a low transition resistance of the interfaces 13 in their narrow sections is thus achieved.

The conductor trace 2 could be extended in the broader sections of the interfaces 13 until they also meet the apertures 11 of the subsequent row(s). This would lead to a further extension of the antenna surface but as well to an undesired reduction of the distance to the vehicle body. The described design of the illustrated embodiment is a good compromise to this, by which both sufficient antenna efficiency and good electrical tuning are achieved.

Thanks to the meander-like conductor trace 2, an electrical extension of the antenna is achieved that can be reduced in length compared to an straight antenna conductor with the same frequency range. In addition, the meander-like structure has improved inductance that results in a better decoupling from a heat conductor antenna 14 that also is provided on the rear windshield 8.

| | |
|---|---|
| Reference Signs | black print |
| vehicle antenna | grey print |
| conductor trace of the antenna | apertures in the grey print |
| structure | roof edge of the metal vehicle |
| feed line conductor trace | body |
| receiver cable | interface |
| vehicle | heat conductor antenna |
| metal vehicle body | |
| obscuring area | |
| rear windshield | |

1. A vehicle antenna with at least one antenna structure that is arranged on a vehicle window mounted in an opening of a metal vehicle body that in a edge area has an obscuring area consisting of nonconductive material and formed by a black print adjoined by a grey print in a direction toward the window center, the black print being a completely black region and the grey print being a black region with grid-like apertures increasing in size in a direction toward the window center and separated by interfaces correspondingly decreasing in size, the antenna structure being provided on the obscuring area, characterized in that the antenna structure is at least partially provided in the area of the grey print and designed such that it is completely covered by the interfaces.

2. The vehicle antenna according to claim 1, characterized-in that the antenna structure is provided at the inner edge of the obscuring area facing the inside of the vehicle.

3. The vehicle antenna according to claim 2, characterized in that the antenna structure is printed on the obscuring area.

4. The vehicle antenna according to claim 1, characterized in that the antenna structure consists of at least one conductor trace that abuts at least the apertures most closely spaced relative to each other.

5. The vehicle antenna according to claim 1, characterized in that the antenna structure consists of at least one conductor trace that is remote from the apertures in the grey print.

6. The vehicle antenna according to claim 1, characterized in that all apertures of a grey print have the same shape.

7. The vehicle antenna according to claim 6, characterized in that the apertures are rectangular in shape, particularly square.

8. The vehicle antenna according to claim 6, characterized in that the apertures are circular.

9. The vehicle antenna according to claim 4, characterized in that the at least one conductor trace has a meander-like shape.

10. The vehicle antenna according to claim 4, characterized in that the at least one conductor trace has a sawtooth-like shape.

11. The vehicle antenna according to claim 1, characterized in that the narrow areas of the interfaces between the apertures with the closest distance to each other are as short and broad as possible.
